(19) United States
(12) Patent Application Publication
(10) Pub. No.: US 2014/0052484 A1
(43) Pub. Date: Feb. 20, 2014

(54) Self-Service Device Paper Tracking

(71) Applicant: Dion L. Bellamy, Weldon Spring, MO (US)

(72) Inventor: Dion L. Bellamy, Weldon Spring, MO (US)

(73) Assignee: BANK OF AMERICA CORPORATION, Charlotte, NC (US)

(21) Appl. No.: 13/586,190

(22) Filed: Aug. 15, 2012

(51) Int. Cl. G06Q 10/10

(52) U.S. Cl. 705/7.13

(57) ABSTRACT

Described are a system, method, apparatus, and computer readable medium that facilitates efficient replenishment of paper, such as receipt paper, at self-service devices. A rate of paper use may be determined for a self-service device. This information may be used to forecast when the paper is expected to be depleted. A time to replace the paper may be selected based on the forecast and on a schedule of other services to be performed at the self-service device. A report including the selected replacement time may be generated and sent to a division responsible for replacing the paper.

### TECHNICAL FIELD

One or more aspects of the disclosure generally relate to computing devices, computing systems, and computer software. In particular, one or more aspects of the disclosure generally relate to computing devices, computing systems, and computer software that may be used by an organization, such as a financial institution or other entity, to replenish paper at self-service devices.

### BACKGROUND

Self-service devices, such as automated teller machines (ATMs), facilitate transactions, such as financial transactions, for customers. The self-service devices may print receipts (e.g., transaction receipts) with information such as a summary of the transaction performed, account information, customer information, and the like. As receipts are printed by a self-service device, the amount of receipt paper held by the self-service device diminishes. Technicians may replenish the receipt paper after all of the paper has been consumed. This may result in downtime until the receipt paper is replenished. Technicians may also replenish the receipt paper based on a visual inspection and estimation of the amount of receipt paper remaining at the self-service device. This may result in wasted paper if the technician's estimation is inaccurate.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

It may be desirable to provide effective techniques for forecasting when receipt paper will be depleted, so that paper may be replaced based on the forecast. Such techniques may potentially be more accurate and/or efficient than conventional methods.

Described is a system, method, device, and/or computer-readable storage device configured to determine an amount of receipt paper remaining and a rate of use of the receipt paper at a first self-service device, forecast a time that the receipt paper at the first self-service device is expected to reach a predetermined level, determine a schedule of services to be performed on the first self-service device, and/or select a time to replace the receipt paper based on the forecasted time and the schedule of services. The system may also be configured to send a report to a department responsible for replacing the receipt paper at the first self-service device. The report may include the selected time.

In some aspects, selecting the time to replace the receipt paper may include identifying, from the schedule of services, a service scheduled to be performed prior to the forecasted time that the receipt paper is expected to reach the predetermined level by a predetermined threshold, and selecting, as the time to replace the receipt paper, a scheduled time for the identified service. Additionally (or alternatively), selecting the time to replace the receipt paper may also include identifying, from the schedule of services, first and second services scheduled to be performed prior to the forecasted time that the receipt paper is expected to reach the predetermined level by a predetermined threshold, and based on a determination that the first service includes accessing an inside of the first self-service device and that the second service does not include accessing the inside of the first self-service device, selecting, as the time to replace the receipt paper, a scheduled time for the identified first service.

In additional aspects, determining the amount of receipt paper remaining and the rate of use may include determining the amount of receipt paper remaining and the rate of use based on at least one characteristic of the following two characteristics: (1) a diameter of a paper roll having the receipt paper, and (2) a thickness of a paper stack having the receipt paper, among other characteristics. Additionally (or alternatively), determining the amount of receipt paper remaining and the rate of use may include determining the amount of receipt paper remaining and the rate of use based on a number and types of transactions performed at the first self-service device during a predetermined time period. Additionally (or alternatively) determining the amount of receipt paper remaining and the rate of use may include determining the amount of receipt paper remaining and the rate of use based on a number and types of transactions performed at the first self-service device during a predetermined time period in response to determining that an imager at the first self-service device used to determine at least one of a diameter of a paper roll having the receipt paper and a thickness of a paper stack having the receipt paper is disabled.

In some aspects, the system may be configured to determine the amount of receipt paper remaining and the rate of use of the receipt paper at each of a plurality of self-service devices including the first self-service device, and in response to the determination, adjust a receipt paper inventory schedule. The receipt paper inventory may be used to replenish receipt paper at the plurality of self-service devices.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 illustrates another example operating environment in which various aspects of the disclosure may be implemented.

FIG. 3A illustrates an example of at least a portion of a flow diagram for tracking paper use at a self-service device in which various aspects of the disclosure may be implemented.

FIG. 3B illustrates an example of at least a portion of a flow diagram for updating an inventory of paper in which various aspects of the disclosure may be implemented.

FIG. 4A illustrates an example table storing paper use information for a self-service device in which various aspects of the disclosure may be implemented.

FIG. 4B illustrates an example graphical display showing paper use information for a self-service device in which various aspects of the disclosure may be implemented.

FIGS. 5A-B illustrate examples of scheduled services to be performed on a self-service device in which various aspects of the disclosure may be implemented.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

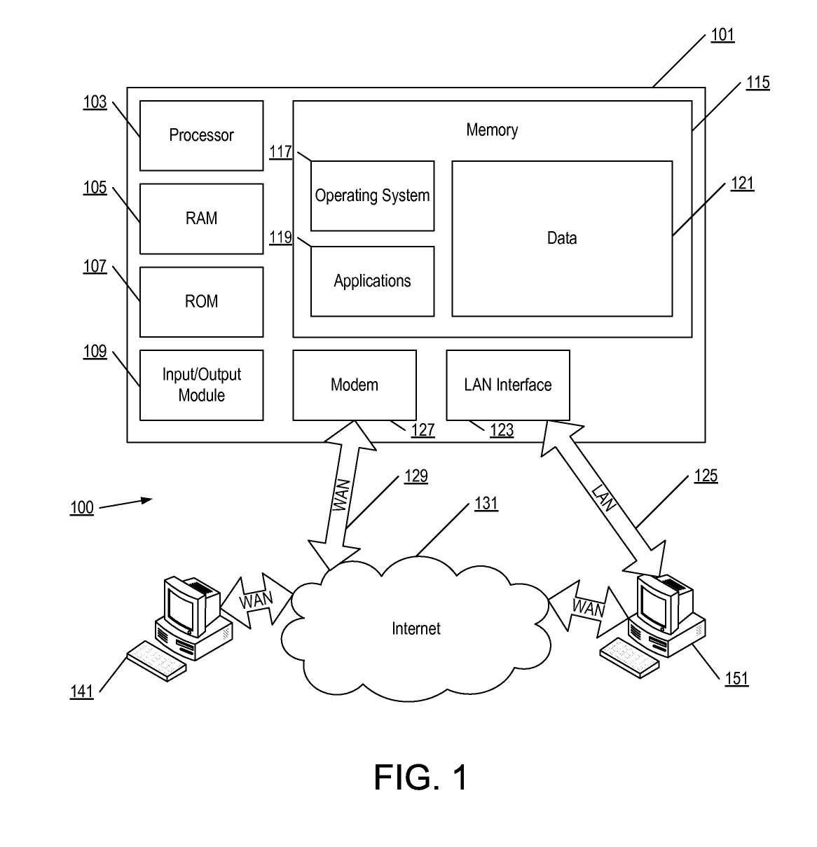

FIG. 1 illustrates an example block diagram of a computing device 101 (e.g., a computer server, desktop computer, laptop computer, tablet computer, and/or other computing devices) in an example computing environment 100 that may be used according to one or more illustrative embodiments of the disclosure. The computing device 101 may have a processor 103 for controlling overall operation of the computing device 101 and its associated components, including for example random access memory (RAM) 105, read-only memory (ROM) 107, memory 115, and/or any other types of computer-readable data storage devices such as disk drives, optical discs, magnetic disks, hard drives, other types of non-transitory computer-readable storage media, etc.; and/or input/output (I/O) module 109.

I/O module 109 may include, e.g., a microphone, mouse, keypad, touch screen, scanner, optical reader, and/or stylus (or other input device(s)) through which a user of computing device 101 may provide input, and may also include one or more of a speaker for providing audio output and a video display device for providing textual, audiovisual, and/or graphical output. Software may be stored within memory 115 and/or other storage to provide instructions to processor 103 for enabling computing device 101 to perform various functions. For example, memory 115 may store software used by the computing device 101, such as an operating system 117, application programs 119, and an associated database 121. Additionally or alternatively, some or all of the computer executable instructions for computing device 101 may be embodied in hardware or firmware (not shown).

The computing device 101 may operate in a networked environment supporting connections to one or more remote computers, such as terminals 141 and 151. The terminals 141 and 151 may be personal computers or servers that include any or all of the elements described above with respect to the computing device 101. The network connections depicted in FIG. 1 include a local area network (LAN) 125 and a wide area network (WAN) 129, but may also include other networks. When used in a LAN networking environment, the computing device 101 may be connected to the LAN 125 through a network interface or adapter 123. When used in a WAN networking environment, the computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed. Computing device 101 and/or terminals 141 or 151 may also be mobile devices (e.g., mobile phones, smartphones, PDAs, notebooks, tablets, other mobile devices) including various other components, such as a battery, speaker, and antennas.

The disclosure is operational with numerous types of general purpose or special purpose computing devices. Examples of well-known computing devices that may be suitable for use with the disclosure (including the system of FIG. 1) include, but are not limited to, desktop computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

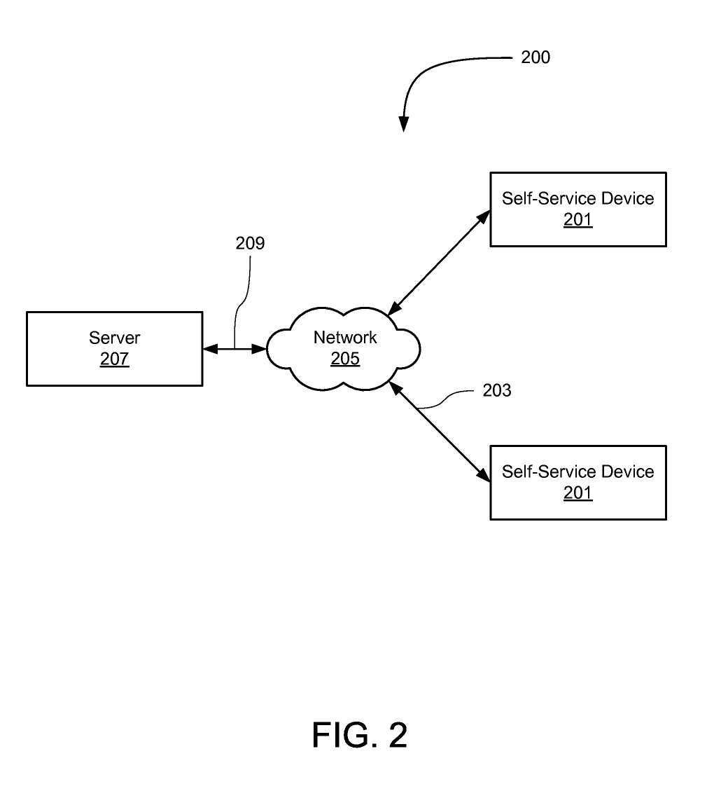

FIG. 2 illustrates an example operating environment in which various aspects of the disclosure may be implemented. An illustrative system 200 for implementing methods according to the present disclosure is shown. Any of the elements 201, 205, and 207 of FIG. 2 may be implemented as or otherwise include one or more computing devices such as the example computing device 101 previously discussed. System 200 may include one or more self-service devices 201. A self-service device 201 may include, for example, an automated teller machine (ATM), a video-assisted transaction device, and other self-service devices. Self-service devices may facilitate transactions and/or communications among a service provider entity (such as a financial institution) and users (e.g., customers of the service provider entity) generally without relying on the services of a human such as a bank teller. The remaining discussion will be in the context of a financial institution service provider entity and financial transactions. However, it will be understood that aspects as disclosed herein may be utilized in the context of any other types of service provider entities and/or any other types of transactions.

Transactions may include, for example, financial transactions, such as fund deposits, fund withdrawals, check cashing, fund advances, funds transfers, payments, general account inquiries, cardless authentications, account servicing, and many other types of transactions. In some aspects, a user may interact with a human agent of the financial institution via a video connection. For example, the agent may answer the user's questions while the user conducts a transaction at the self-service device. Self-service devices 201 may be connected by one or more communications links 203 to a network 205.

Self-service devices may have output devices for presenting information to and/or otherwise interacting with the user. For example, a self-service device may include a printer for printing paper transaction receipts. The self-service device may also have a display device, such as a monitor to display an image of the transaction receipt (e.g., a digital receipt). Additionally or alternatively, a digital receipt of the transaction may be sent to the user's account, such as an e-mail account, an account with the financial institution, and the like. In some aspects, users may opt in or opt out of receiving receipts (paper and/or digital). For example, the user may request to receive a paper receipt and a digital receipt for the transaction. Alternatively, the user may request to receive a digital receipt, but not a paper receipt.

System 200 may also include one or more servers 207 and/or other types of computing devices, which may be, e.g., any suitable server, processor, computer, or data processing device, or combination of the same. Servers 207 may be owned, managed, and/or operated by a financial institution. Servers 207 may be connected by one or more communications links 209 to network 205. As will be described in further detail in the examples below, servers 207 may receive information from self-service devices and/or other information sources indicating the rate of paper use and/or amount of paper, such as receipt paper, remaining at the self-service devices. Servers 207 may generate data representing reports recommending a replacement schedule for the paper based on the rate of use and/or the amount of paper remaining Any of the elements in FIG. 2 may be implemented as one or more computing device, such as the example computing device 101 described in connection with FIG. 1.

Network 205 may be any suitable network or combination of networks such as the Internet, an intranet, a wide-area network (WAN), a local-area network (LAN), a wireless network, a digital subscriber line (DSL) network, a frame relay network, an asynchronous transfer mode (ATM) network, a virtual private network (VPN), a cellular network, or any combination of any of the same. Communications links 203 and 209 may be any communications links suitable for communicating among self-service devices 201, servers 207, and/or other devices, such as network links, dial-up links, wireless links, hard-wired links, other communications links.

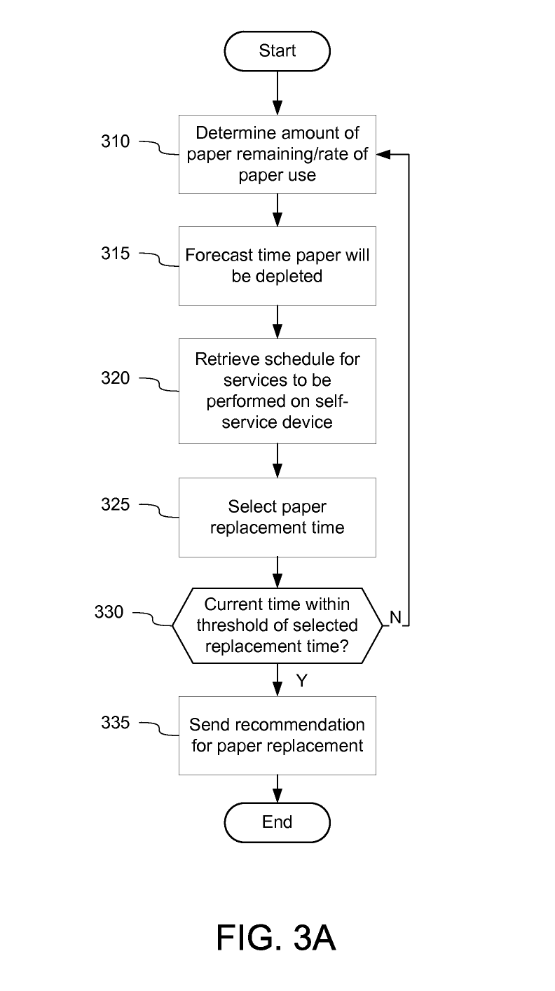

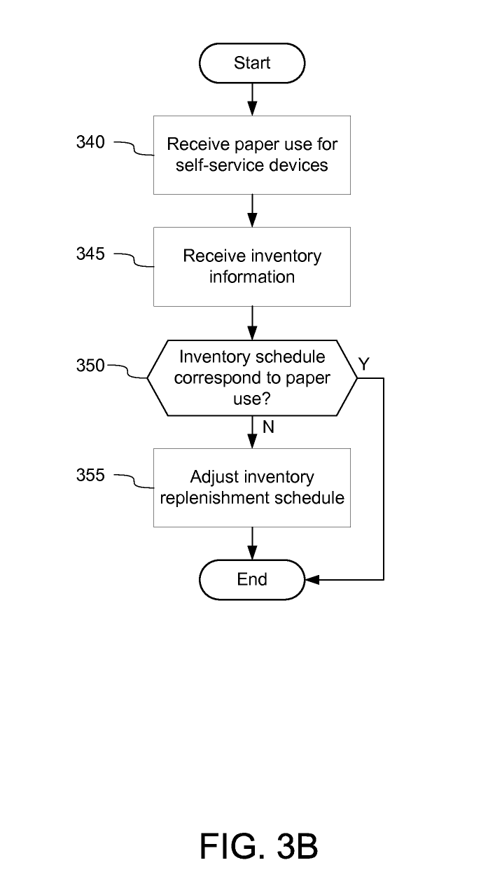

FIG. 3A illustrates an example of at least a portion of a flow diagram for tracking paper use at a self-service device (such as one of the self-service devices 201) in which various aspects of the disclosure may be implemented. In step 310, a computing device (such as server 207) may receive an indication of the amount of paper, such as receipt paper, remaining at the self-service device. The amount of paper remaining may be determined in any of various ways. For example, information identifying the starting amount of paper (e.g., an amount of paper on a standard replacement roll or stack of receipt paper) may be stored by the self-service device each time paper at the self-service device is replaced. A technician replacing the paper may, for example, manually input the starting amount. Alternatively, the self-service device may determine the starting amount by detecting the size of the replacement paper stack or spool (e.g., thickness of a paper stack, diameter of a paper spool, and the like). The self-service device may track the amount of paper remaining based on the amount of paper used over a period of time (e.g., per hour, per day, and the like) and/or based on the types of transactions performed at the self-service device. The linear amount of paper used may be tracked. For example, the starting amount may be 5,000 feet of paper (e.g., a full stack or spool of paper). If 200 feet of paper is used on the first day, the self-service device may determine that 4,800 feet remain. This information may be sent to the server 207 for processing. The self-service device may also track the size of the replacement paper stack or spool (e.g., thickness of paper stack, diameter of paper spool, and the like) to determine the amount of paper remaining For example, if a three inch stack of receipt paper remains, the self-service device may determine that 1,000 linear feet remain. If an eight inch (in diameter) paper spool is detected, the self-service device may determine that 700 feet remain. The correspondence between the linear length of remaining paper and the diameter/thickness of the paper may depend on the type of paper used, including thickness of the paper, density of stacking, and/or any other factors. The self-service device may include an internal camera, laser, and/or other imaging device to determine the thickness or diameter of paper remaining

As mentioned above, the amount of paper remaining or dispensed by the self-service device may be determined based on the number and types of transactions performed at the self-service device. The computing device may determine the amount of paper remaining based on transactions if, for example, the self-service device does not have imaging devices (e.g., internal camera, laser, or other imaging devices) to determine the thickness or diameter of the remaining receipt paper and/or the imaging devices have been disabled, such as in the event of a malfunction of the imaging devices. A predetermined amount of receipt paper may be known to be used for each type of transaction. For example, a first length of paper (e.g., an eight inch receipt) may be printed for a first type of transaction (e.g., a check deposit). The receipt may include customer information, an image of the deposited check, and other transaction information (e.g., check amount). A different second length of paper (e.g., a three inch receipt) may be printed for a different second type of transaction (e.g., a cash withdrawal). The receipt may include customer information and transaction information. Other transaction types may include (as previously described) fund deposits, fund withdrawals, check cashing, and the like, each with their own associated lengths of paper, some of which may be the same lengths and some of which may be different lengths.

For each transaction type, the user may have different options for printing receipts. For example, the self-service device may present an option for the user to opt in/opt out of printing an image of a deposited check. If the user opts out, the receipt may exclude an image of the check, and so the paper receipt might be of a shorter length than if the image were included (e.g., three inches in length). If the user opts in, the receipt may include an image of the check and might be eight inches in length. The self-service device may also present users with the option to include receive offers (e.g., promotions, advertisement, and the like) or other information on the printed receipt that may also affect the known length of the paper receipt. In some aspects, the offers may be a predetermined length, such as four inches. Based on the option(s) that the user selects or rejects, the self-service device may adjust the amount of receipt paper used for the transaction. For example, the user may opt out of check images and opt in for offers in a check deposit transaction. The resulting transaction receipt may be seven inches (e.g., three inches for transaction and customer information and four inches for offers). Thus, the types of transactions and any options associated with those transactions may be associated with known predetermined lengths of paper. The length of paper to be used for a given transaction therefore may be determined based on the type of the transaction and possibly also any options associated with the transaction. This may be done using, e.g., a lookup table and/or a deterministic mathematical algorithm.

In some instances, users may opt out of a receipt entirely. The self-service device may exclude those transactions from the paper amount calculation. The self-service device may aggregate all of the transactions (and corresponding receipt paper amounts) to determine the amount of receipt paper used over a particular time period (e.g., one hour, one day). In some aspects, the self-service device might not itself determine the amount of paper used. Instead, the self-service device may, e.g., transmit to another computing device (e.g., server 207) information identifying the number and/or types of transactions performed at the self-service device and/or the options that users selected or rejected for each transaction. The computing device may aggregate the received information and determine (e.g., calculate) the amount of receipt paper used at the self-service device over a particular time period.

The information received at the computing device may be in any format. For example and as previously described, the computing device may receive information identifying the amount of paper used over a period of time (e.g., 55 feet of paper used on a Monday or 2.29 feet per hour). Alternatively (or additionally), the computing device may receive information identifying the start and/or end amounts of paper for the self-service device (e.g., starting amount of 700 feet of paper and ending amount of 645 feet of paper).

In step 315, based on the determination at step 310, the computing device may forecast the time (e.g., the hour, the day, or other resolution of time) that (and/or the time remaining before) the paper at the self-service device is expected to be completely consumed and/or the amount of paper is expected to reach a predetermined threshold (e.g., 40 feet remaining) To generate the prediction, the computing device may consider, for example, for each of the self-service devices, the rate of use of the paper, the amount of paper remaining, and/or the starting amount of paper at the self-service device. For each self-service device, the computing device may maintain and update a database storing this information.

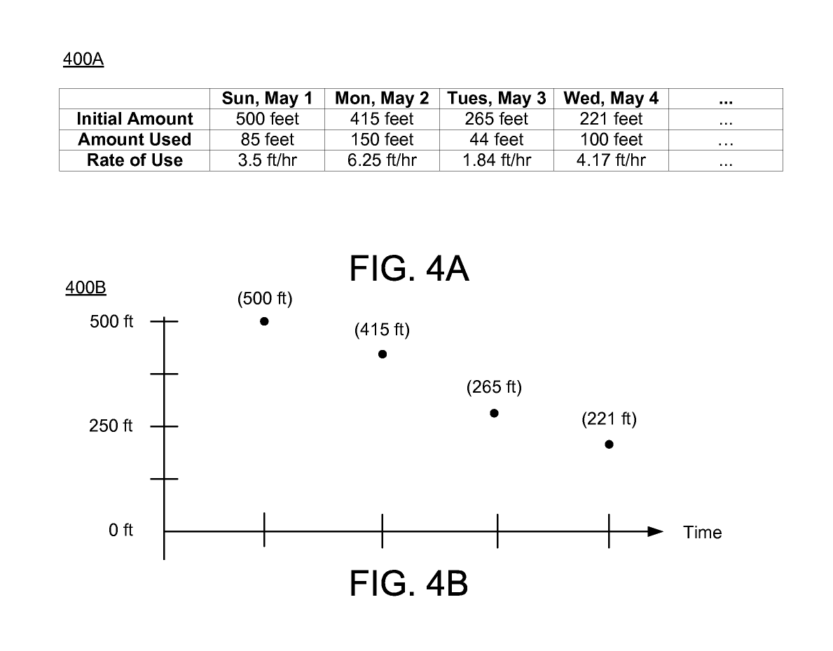

FIG. 4A illustrates an example table 400A storing paper use information for a self-service device in which various aspects of the disclosure may be implemented. The table 400A may be stored and/or accessed using any data format (such as in the form of a relational database), and may be stored at one or more computer-readable data storage devices accessible by the computing device. There may be an associated table for each of the self-service devices, and/or a single table may combine the information for a plurality of the self-service devices. The table may be updated with new information received from and/or generated by the self-service device (e.g., as received in step 310). For example, the table 400A may store information identifying the starting amount of paper at the beginning of a particular day (e.g., 500 feet on May 1), the amount of paper used on that day (e.g., 85 feet), and the rate of use (e.g., 3.5 feet per hour). The table may also store paper use information for May 2 and May 3. When the computing device receives updated information on paper use for May 4, the computing device may update the table with the this information (e.g., for May 4, an initial amount of 221 feet, 100 feet used, and 4.17 feet used per hour). The computing device may maintain and/or update one or more tables for each self-service device. Graphical displays corresponding to one or more pieces of information from the table 400A may also be generated by the computing device. FIG. 4B illustrates an example graphical display 400B showing paper use information for a self-service device in which various aspects of the disclosure may be implemented. Example graphical display 400B illustrates the starting amount of paper at the beginning of each day corresponding to the data stored in table 400A. The time that paper will be depleted at the self-service device may be forecasted (e.g., estimated) using the information stored in table 400A.

In step 320, the computing device may determine (e.g., retrieve) a schedule for services to be performed on the self-service device. The schedule may be stored as data by any one or more computer-readable data storage devices accessible by the computing device. Example services include maintenance (e.g., part replacement, device repair, routine maintenance, and the like), replenishment/emptying of other supplies (e.g., deposit envelopes, pamphlets, ink, and the like) and media (e.g., cash, coins, checks, and the like), external visual inspection of the self-service device by the technician, internal visual inspection of the self-service device by the technician, removal of jammed media (e.g., jammed coins, checks, and the like), verification of functionality (e.g., a technician conducting proxy transactions to verify that the self-service device performs transactions as intended), and other services. The schedule may be dynamically changed as new service activities for the self-service device are added or removed. As will be described in further detail in the examples below, services may be scheduled at regular intervals (e.g., every day, every other day, every week, and the like).

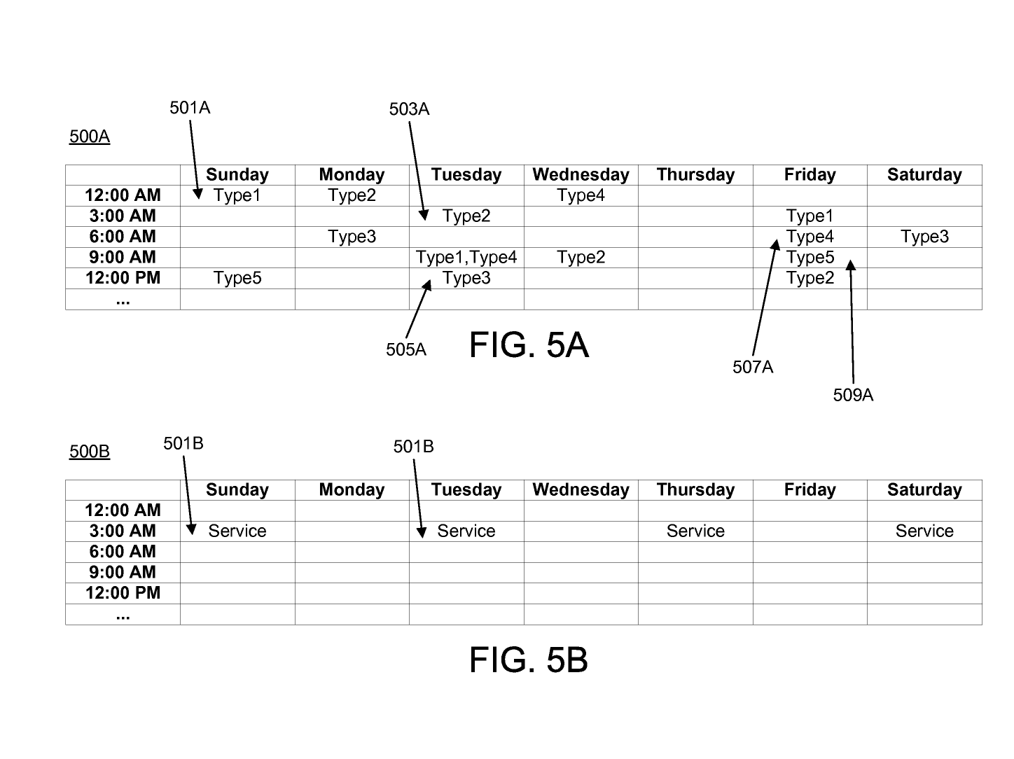

FIG. 5A illustrates an example of a schedule of services 500A to be performed on a self-service device in which various aspects of the disclosure may be implemented. For example, a service of Type1 may be scheduled for Sunday at 12:00 AM (501A). A service of Type2 may be scheduled for Tuesday at 3:00 AM (503A). A service of Type3 may be scheduled for Tuesday at 12:00 PM (505A). A service of Type4 may be scheduled for Friday at 6:00 AM (507A). A service of Type5 may be scheduled for Friday at 9:00 AM (509A). Each type of service (e.g., Types 1-5) may or may not involve opening the self-service device and/or otherwise accessing the compartment housing the paper stack or roll. The schedule 500A may indicate whether each type of transaction involves opening the self-service and/or accessing the paper stack or roll. For example, a “1” for a service type may indicate that opening the self-service device is required for that type of service, and a “0” may indicate that opening the self-service device is not required.

If a particular service type involves opening the self-service device (such that the paper compartment is accessed or more easily accessible), the service type may be identified as an opportunity to replenish paper at the device. For example, service types Type1, Type4, and Type5 (e.g., removing a check jam, replenishing a cash compartment, emptying a check bin, and the like) may involve opening the self-service device and therefore be identified as an opportunity to replenish paper at the device. If a particular service type does not involve opening the self-service device (or accessing the paper compartment), the service type might not be identified as an opportunity to replenish paper. For example, service types Type2 and Type3 (e.g., external visual inspection of device, verification of device functionalities, and the like) might not require opening the self-service device and therefore might not be identified as an opportunity to replenish paper at the device. Selecting the time to replenish paper will be described in further detail in the examples below.

FIG. 5B illustrates another example of a schedule of services 500B to be performed on a self-service device in which various aspects of the disclosure may be implemented. Services on the self-service device may occur at regular intervals (e.g., every other day, as illustrated in FIG. 5B). For example, service may be scheduled for 3:00 AM on Sunday, Tuesday, Thursday, and Saturday (501B). Each of the types of services scheduled for a particular day (such as Type1 and Type5 services on Sunday, as illustrated in FIG. 5A) may be grouped together and scheduled to occur during the same visit on that day (e.g., 3:00 AM on Sunday, as illustrated in FIG. 5B). Services falling on days not having a scheduled service (e.g., Type2 and Type3 service on Monday) may be grouped with days when services are scheduled to be performed (e.g., Sunday or Tuesday). If any of the services within a group involves opening the self-service device (or accessing the paper compartment), the group as a whole may be considered as involving opening the self-service device (or accessing the paper compartment). For example, services grouped together for Tuesday may include Type1, Type2, Type3, and Type4 services. Type2 and Type3 services might not involve opening the self-service device. Nevertheless, the Tuesday group may still be considered as involving opening the self-service device because the group includes Type1 and Type4 services (which may involve opening the self-service device).

In step 325, the computing device may select a time to replace paper based on the forecast for when paper will run out (as determined in step 315) and on other scheduled services to be performed on the self-service device (as identified in step 320). In order to save on the number of service trips to a particular self-service device, one of the time periods for other scheduled services may be selected for paper replenishment. For example, the closest service time occurring prior to the expected time that paper will run out may be selected. Alternatively, the closest service time occurring prior to the expected depletion time by a predetermined time threshold, such as 24 hours, may be selected. For instance, with reference to FIG. 5A, if the computing device determines that paper will run out on Monday, the computing device may schedule paper replenishment to occur at 12:00 PM on Sunday, when a Type5 service (which involves opening the self-service device) is scheduled to occur. If the paper is expected to run out on Monday at 9:00 AM, the computing device may select 12:00 AM on Sunday (instead of 12:00 PM) to replace the paper if a predetermined threshold is 24 hours. The threshold may function as a safety buffer and/or to account for unexpected spikes in paper use that may occur just prior to the scheduled paper replacement time. On the other hand, paper replenishment might not be scheduled for any of the time periods on Monday because the Type2 and Type3 services might not involve opening the self-service device and/or the paper-holding compartment.

In step 330, the computing device may determine whether the current time is within a threshold of the selected replacement time. For example, a threshold may be two days. If 12:00 PM on Sunday is selected and the current time is 9:00 AM on Saturday, the computing device may determine that the current time is within a threshold of the selected replacement time (step 330: Y). If the current time is 9:00 AM on Friday, the computing device may determine that the current time is not within a threshold (step 330: N). Because the current time is outside the threshold, the computing device may continue to update and receive information from the self-service devices (step 310), forecasting depletion time (step 315), and/or selecting paper replacement times (step 325) until the current time comes within the predetermined threshold of the selected paper replacement time.

In step 335, the computing device may generate and/or send a recommendation report to a department at a financial institution (or third-party service/maintenance provider) that handles self-service device service/maintenance and/or paper replenishment, such as a transportation department. The recommendation report may indicate the selected paper replacement time (e.g., 12:00 PM, Sunday, May 1). The report may also indicate other services scheduled to be performed at the selected time (e.g., Type5 service). The report may also provide alternate suggested paper replacement times. The computing device may select, as an alternate, another available time corresponding to another service/maintenance that includes opening the self-service device and/or accessing the paper compartment. For example, referring to FIG. 5A, the report may indicate 12:00 AM, Sunday as an alternate paper replacement time. FIG. 3A illustrates that step 335 is performed after the computing device determines that the current time is within a time threshold of the selected paper replacement time. However, step 330 and other steps may be optional, and step 335 may be performed at any time after a paper replacement time has been selected.

FIG. 3B illustrates an example of at least a portion of a flow diagram for updating an inventory of paper in which various aspects of the disclosure may be implemented. In step 340, a computing device (such as server 207) may receive paper use information for a plurality of self-service devices. The use information for each self-service device may include the rate of paper use, amount of paper remaining, and/or a starting and end amount of paper at the self-service device. The use information may also include the forecast for when the paper is expected to be completely consumed (e.g., as determined in step 315 for each self-service device) and/or the selected paper replacement time for each self-service device (e.g., as determined in step 325). The information may be aggregated for the plurality of self-service devices.

In step 345, the computing device may receive information on the current inventory of paper rolls, paper stacks, and/or other paper supplies. This information may indicate, for example, the amount of paper currently in inventory (e.g., 400 paper rolls) and/or the inventory replenishment schedule (e.g., inventory receives 3500 paper rolls each month). In step 350, the computing device may compare the aggregated paper use information from the self-service devices to the inventory information to determine whether the current supply of paper and the inventory replacement schedule is sufficient to satisfy paper use at the self-service devices. The computing device may determine whether present paper use and/or forecasted use falls within a predetermined threshold of the amount of paper scheduled to be delivered to inventory during a period of time (e.g., shipments for each month). For example, the inventory schedule may indicate that 3500 rolls of paper are scheduled to be shipped to inventory each month. A predetermined threshold for the inventory schedule may be, e.g., 100 rolls. If aggregated paper use information indicates that 3450 rolls are expected to be used by the self-service devices each month, the computing device may determine that inventory is sufficient to satisfy current paper demands (step 350: Y). On the other hand, if aggregated paper use information indicates that 3300 rolls (or 3700 rolls) are expected to be used by the self-service devices each month, the computing device may determine that inventory does not correspond the expected paper use (step 350: N). If the expected paper use does not correspond to paper inventory, the computing device may adjust the inventory replenishment schedule in step 355. For example, if 3300 rolls are expected to be used in a month, the computing device may adjust inventory to replenish at 3300 rolls every month (or a predetermined number above the expected use, such as 3350 rolls every month).

Various aspects described herein may be embodied as a method, an apparatus, or as computer-executable instructions stored on one or more non-transitory and/or tangible computer-readable media. Accordingly, those aspects may take the form of an entirely hardware embodiment, an entirely software embodiment (which may or may not include firmware) stored on one or more non-transitory and/or tangible computer-readable media, or an embodiment combining software and hardware aspects. Any and/or all of the method steps described herein may be embodied in computer-executable instructions stored by one or more computer-readable data storage devices (e.g., computer-readable storage media. Moreover, one or more computing devices may have access to the stored instructions so as to perform such method steps when the one or more computing devices execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. One or more computer-readable data storage devices storing computer-executable instructions that, when executed, are configured to cause at least one computing device to:
determine an amount of receipt paper remaining and a rate of use of the receipt paper at a first self-service device;
forecast a time that the receipt paper at the first self-service device is expected to reach a predetermined level;
determine a schedule of services to be performed on the first self-service device; and
select a time to replace the receipt paper based on the forecasted time and the schedule of services.

2. The one or more computer-readable data storage devices of claim 1, storing additional computer-executable instructions that, when executed, are configured to cause the at least one computing device to:
send a report to a department responsible for replacing the receipt paper at the first self-service device, wherein the report includes the selected time.

3. The one or more computer-readable data storage devices of claim 1, wherein said selecting the time to replace the receipt paper comprises:
identifying, from the schedule of services, a service scheduled to be performed prior to the forecasted time that the receipt paper is expected to reach the predetermined level by a predetermined threshold; and
selecting, as the time to replace the receipt paper, a scheduled time for the identified service.

4. The one or more computer-readable data storage devices of claim 1, wherein said selecting the time to replace the receipt paper comprises:
identifying, from the schedule of services, first and second services scheduled to be performed prior to the forecasted time that the receipt paper is expected to reach the predetermined level by a predetermined threshold; and
based on a determination that the first service includes accessing an inside of the first self-service device and that the second service does not include accessing the inside of the first self-service device, selecting, as the time to replace the receipt paper, a scheduled time for the identified first service.

5. The one or more computer-readable data storage devices of claim 1, wherein said determining the amount of receipt paper remaining and the rate of use comprises determining the amount of receipt paper remaining and the rate of use based on at least one characteristic of the following two characteristics: (1) a diameter of a paper roll having the receipt paper, and (2) a thickness of a paper stack having the receipt paper.

6. The one or more computer-readable data storage devices of claim 1, wherein said determining the amount of receipt paper remaining and the rate of use comprises determining the amount of receipt paper remaining and the rate of use based on a number and types of transactions performed at the first self-service device during a predetermined time period.

7. The one or more computer-readable data storage devices of claim 6, wherein said determining the amount of receipt paper remaining and the rate of use comprises determining the amount of receipt paper remaining and the rate of use based on a number and types of transactions performed at the first self-service device during a predetermined time period in response to determining that an imager at the first self-service device used to determine at least one of a diameter of a paper roll having the receipt paper and a thickness of a paper stack having the receipt paper is disabled.

8. The one or more computer-readable data storage devices of claim 1, storing additional computer-executable instructions that, when executed, are configured to cause the at least one computing device to:
determine the amount of receipt paper remaining and the rate of use of the receipt paper at each of a plurality of self-service devices including the first self-service device; and
in response to the determination, adjust a receipt paper inventory schedule, wherein the receipt paper inventory is used to replenish receipt paper at the plurality of self-service devices.

9. A method, comprising:
determining an amount of paper remaining and a rate of use of the paper at a first self-service device;
forecasting a time that the paper at the first self-service device is expected to reach a predetermined level;
determining a schedule of services to be performed on the first self-service device; and
selecting a time to replace the paper based on the forecasted time and the schedule of services.

10. The method of claim 9, further comprising:
sending a report to a department responsible for replacing the paper at the first self-service device, wherein the report includes the selected time.

11. The method of claim 9, wherein said selecting the time to replace the paper comprises:
identifying, from the schedule of services, a service scheduled to be performed prior to the forecasted time that the paper is expected to reach the predetermined level by a predetermined threshold; and
selecting, as the time to replace the paper, a scheduled time for the identified service.

12. The method of claim 9, wherein said selecting the time to replace the paper comprises:
identifying, from the schedule of services, first and second services scheduled to be performed prior to the forecasted time that the paper is expected to reach the predetermined level by a predetermined threshold; and
based on a determination that the first service includes accessing an inside of the first self-service device and that the second service does not include accessing the inside of the first self-service device, selecting, as the time to replace the paper, a scheduled time for the identified first service.

13. The method of claim 9, wherein said determining the amount of paper remaining and the rate of use comprises determining the amount of paper remaining and the rate of use based on at least one characteristic of the following two characteristics: (1) a diameter of a paper roll having the paper, and (2) a thickness of a paper stack having the paper.

14. The method of claim 9, wherein said determining the amount of paper remaining and the rate of use comprises determining the amount of paper remaining and the rate of use based on a number and types of transactions performed at the first self-service device during a predetermined time period.

15. The method of claim 14, wherein said determining the amount of paper remaining and the rate of use comprises determining the amount of paper remaining and the rate of use based on a number and types of transactions performed at the first self-service device during a predetermined time period in response to determining that an imager at the first self-service device used to determine at least one of a diameter of a paper roll having the paper and a thickness of a paper stack having the paper is disabled.

16. The method of claim 9, further comprising:
determining the amount of paper remaining and the rate of use of the paper at each of a plurality of self-service devices including the first self-service device; and
in response to the determination, adjusting a paper inventory schedule, wherein the paper inventory is used to replenish paper at the plurality of self-service devices.

17. An apparatus, comprising:
one or more processors;
memory storing computer-readable instructions that, when executed by the one or more processors, cause the apparatus to:
determine an amount of receipt paper remaining and a rate of use of the receipt paper at a first self-service device;
forecast a time that the receipt paper at the first self-service device is expected to reach a predetermined level;
determine a schedule of services to be performed on the first self-service device;
select a time to replace the receipt paper based on the forecasted time and the schedule of services; and
send a report to a department responsible for replacing the receipt paper at the first self-service device, wherein the report includes the selected time.

18. The apparatus of claim 17, wherein said selecting the time to replace the receipt paper comprises:
identifying, from the schedule of services, a service scheduled to be performed prior to the forecasted time that the receipt paper is expected to reach the predetermined level by a predetermined threshold; and
selecting, as the time to replace the receipt paper, a scheduled time for the identified service.

19. The apparatus of claim 17, wherein said determining the amount of receipt paper remaining and the rate of use comprises determining the amount of receipt paper remaining and the rate of use based on a number and types of transactions performed at the first self-service device during a predetermined time period in response to determining that an imager at the first self-service device used to determine at least one of a diameter of a paper roll having the receipt paper and a thickness of a paper stack having the receipt paper is disabled.

20. The apparatus of claim 17, wherein the memory stores additional computer-readable instructions that, when executed, are configured to cause the apparatus to:
determine the amount of receipt paper remaining and the rate of use of the receipt paper at each of a plurality of self-service devices including the first self-service device; and
in response to the determination, adjust a receipt paper inventory schedule, wherein the receipt paper inventory is used to replenish receipt paper at the plurality of self-service devices.
